(19) United States
(12) Patent Application Publication
(10) Pub. No.: US 2006/0067403 A1
(43) Pub. Date: Mar. 30, 2006

(54) Information processing device and information processing method

(75) Inventor: Ryuji Sakai, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/217,485

(22) Filed: Sep. 2, 2005

(30) Foreign Application Priority Data
Sep. 30, 2004 (JP) 2004-287917

(51) Int. Cl. H04N 7/12; H04N 11/04; H04N 11/02; H04B 1/66

(52) U.S. Cl. 375/240.12; 375/240.01

(57) ABSTRACT

An information processing device includes a first unit which extracts intra prediction information included in a bit stream of video codec, and a second unit which converts the resolution of image data into an image whose resolution is higher than that of an original image, wherein the second unit converts the pixels into high resolution images by performing interpolation processing for pixels of the image data on the basis of the intra prediction information.

### CROSS-REFERENCE TO RELATED APPLICATIONS

This application is based upon and claims the benefit of priority from prior Japanese Patent Application No. 2004-287917, filed Sep. 30, 2004, the entire contents of which are incorporated herein by reference.

### BACKGROUND OF THE INVENTION

1. Field of the Invention

The present invention relates to an information processing device and an information processing method.

2. Description of the Related Art

When video data with low resolution is to be displayed on a display with high resolution, pixels thereof are interpolated by appropriate filter calculation according to characteristics of the video data. For example, in IP (Interlace/progressive) converting process, it is necessary to interpolate image data per one line when an interlaced image is to be converted into a progressive image. In this case, when movement is small, pixels are interpolated by use of data of previous and next field images. Meanwhile, when movement is large, pixels are obtained through filter calculation on the basis of pixels with low resolution. Further, also when a moving image of SD (Standard Definition) size is to be converted into one of HD (High Definition) size, pixels are interpolated by pixel data that is filter calculated so as to meet images of HD size, on the basis of pixels of SD images with low resolution.

In the case of interpolating pixels as described above, pixels are obtained through filter calculations, accordingly, for an image with edges, the image must become a blurred one, which has been a problem with the prior art.

H.264 draws up an improvement of compression ratio by intra prediction, but it does not make any proposal for applying intra prediction to conversion from low resolution data to high resolution data. (Refer to pages 107 and 108, H.264/AVC text book published by Impress.)

### BRIEF SUMMARY OF THE INVENTION

An information processing device according to an aspect of the present invention is characterized by comprising: means for extracting intra prediction information included in a bit stream of video codec; and means for converting the resolution of image data into an image whose resolution is higher than that of an original image, wherein the means for converting the resolution converts the pixels into high resolution images by performing interpolation processing for pixels of the image data on the basis of the intra prediction information. Namely, images to be interpolated are calculated by use of a prediction direction of intra prediction, and information of prediction precision of the intra prediction.

When an intra prediction is close to its original image, by quantifying intra prediction precision and adding it to parameters, a high-definition image can be generated by increasing weight of interpolation pixel data using intra prediction data.

The present invention is embodied as not only a device but also a method.

### BRIEF DESCRIPTION OF THE SEVERAL VIEWS OF THE DRAWING

FIG. 1 is a diagram showing a schematic configuration concerning image processing of an information processing device according to one embodiment of the present invention;

FIGS. 2A to 2H are views for explaining modes of intra prediction;

FIG. 3 is a view showing an example of an interpolation method by ordinary filter processing;

FIGS. 4A to 4D are views showing an example of an interpolation method by intra prediction;

FIG. 5 is a view showing an example of intra prediction mode conditions in part of an image; and

FIGS. 6A to 6C are a flow chart and views for calculating interpolation pixel data according to one embodiment of the present invention.

### DETAILED DESCRIPTION OF THE INVENTION

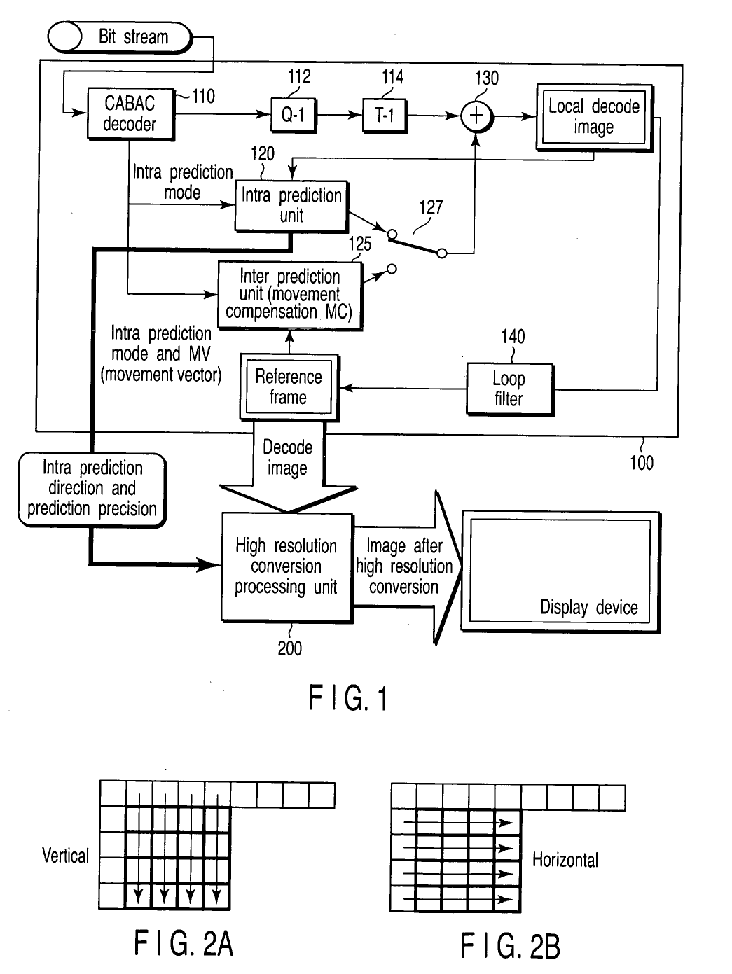

Embodiments of the present invention will be illustrated in more details with reference to the accompanying drawings hereinafter. FIG. 1 is a diagram showing a schematic configuration concerning image processing of an information processing device according to one embodiment of the invention.

The configuration shown in FIG. 1 is a configuration concerning a decoder 100 that enables intra prediction, such as H.264. As shown in FIG. 1, a bit stream is input to a CABAC decoder 110. The CABAC decoder 110 outputs a value obtained by performing discrete cosine transform and quantization of a residual error signal in unit of macro block, and a mode whether intra prediction or inter prediction. Further, the CABAC decoder 110 outputs values such as motion vectors in the case of inter prediction. The dispersion cosine transformed and quantized value among the output signals from the CABAC decoder 110 is inverse quantized and reserve dispersion cosine transformed by a inverse quantization unit 112 and a inverse discrete cosine transform unit 114, respectively, and is input into an adder 130. On the other hand, an intra prediction mode is output from the CABAC decoder 110 to an intra prediction unit 120 according to prediction modes, and an inter prediction mode and a motion vector are output to an inter prediction unit 125. The intra prediction unit 120 outputs an intra prediction signal on the basis of the intra prediction signal and a local decode image whose details are described later herein. Further, the inter prediction unit 125 outputs an inter prediction signal on the basis of the inter prediction mode, the motion vector, and a reference frame whose details are described later herein.

From the intra prediction unit 120 or the inter prediction unit 125, either of the prediction signals is output to the adder 130 according to the prediction mode by means of a mode determining unit 127. The adder 130 adds the output value from the inverse discrete cosine transform unit 114 and the prediction signal from the mode determining unit 127, and outputs a local decode image. The local decode image is input to the above-mentioned intra prediction unit 120 and a loop filter 140. The loop filter 140 reduces block noises of the input local decode image, and generates a decode image as a reference frame. The reference frame is utilized as a reference frame for inter prediction.

The decode image output from the loop filter 140 is output to a high resolution conversion processing unit 200, and is converted into a high resolution image by the high resolution conversion processing unit 200. A decode image converted into a high resolution image is displayed on a display device. At this moment, the process to increase the resolution is ordinarily performed by interpolating the pixel data in original image data. In the invention, however, in order to enhance the resolution of video images output from the decoder 100, interpolation processing is performed on the basis of the intra prediction mode (specifically, intra prediction direction) predicted by the intra prediction unit 120 and thereby the resolution of video images is enhanced. In this case, because prediction precision is calculated at the time of decoding, it is determined how much the intra prediction information is used (to what degree the intra prediction information is weighted) in the interpolation processing according to this prediction precision. Accordingly, when the intra prediction precision is low, weight on the conventional interpolation processing may be increased, or only the conventional interpolation processing may be performed. Note that, in FIG. 1, the high resolution conversion processing unit 200 is not included in the decoder 100, but it may be included therein.

In the present embodiment, in order to enhance the resolution of decode images after decoding processing by the decoder, information of the intra prediction direction that the prediction mode of intra prediction shows (intra prediction mode), and differential (residual signal) information from original images at intra prediction are stored into a main memory (not shown). Thereafter, these information items are used when enhancing the resolution of decoded video images.

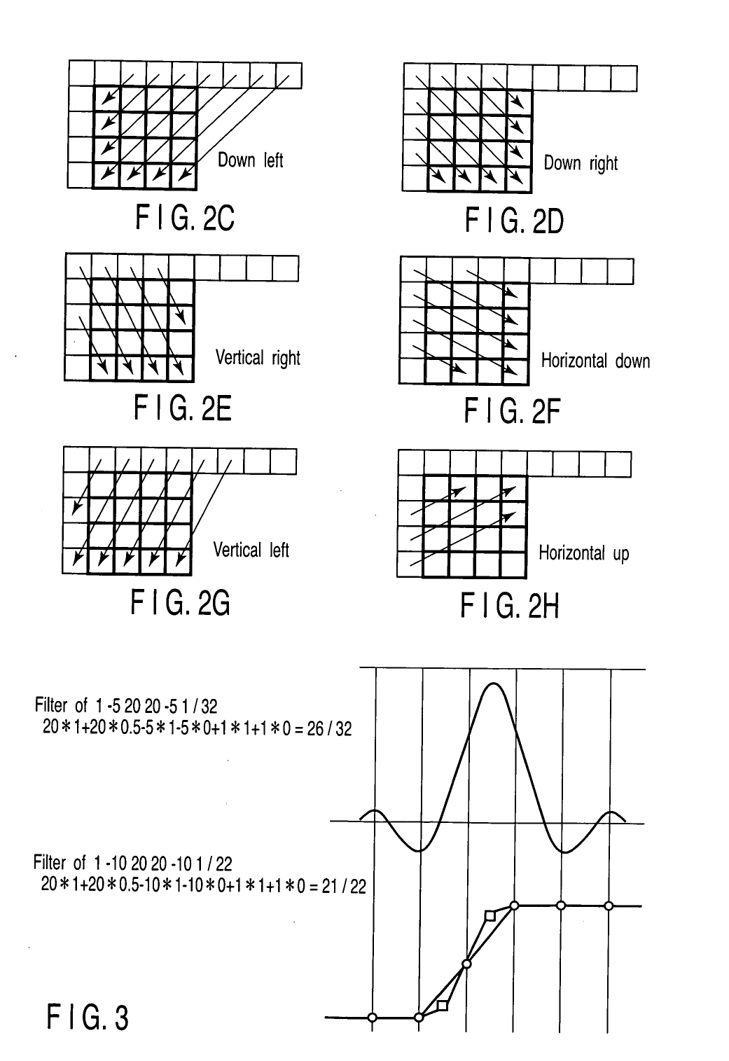

In the intra prediction, with respect to a rectangular block shape image area (for example, 4×4 pixels), values of pixel data in the block are predicted by use of decoded pixel data around the block, as shown in FIGS. 2A to 2H. In which direction the peripheral pixel data is developed to obtain the pixels in the block is encoded in a value called intra prediction mode. The intra prediction mode includes nine modes in total of modes in eight directions shown in FIGS. 2A to 2H and a mode whose development direction is not specified. FIGS. 2A and 2B show the cases of development in vertical and horizontal directions, FIGS. 2C and 2D show the cases of development in down left and down right directions, and FIGS. 2E to 2H show the cases of development in vertical right, horizontal down, vertical left and horizontal up directions, respectively. The prediction mode, and information of a differential signal from a predicted value are obtained at the time of decoding video data. These values are stored into the main memory as described previously.

In order to obtain the interpolation data, the ordinary resolution conversion processing calculates interpolation pixels uniformly from peripheral pixels by filter processing as shown in FIG. 3, or alternatively calculates interpolation pixels by changing the filter calculation according to value differences among pixels, so as to obtain more high-definition images.

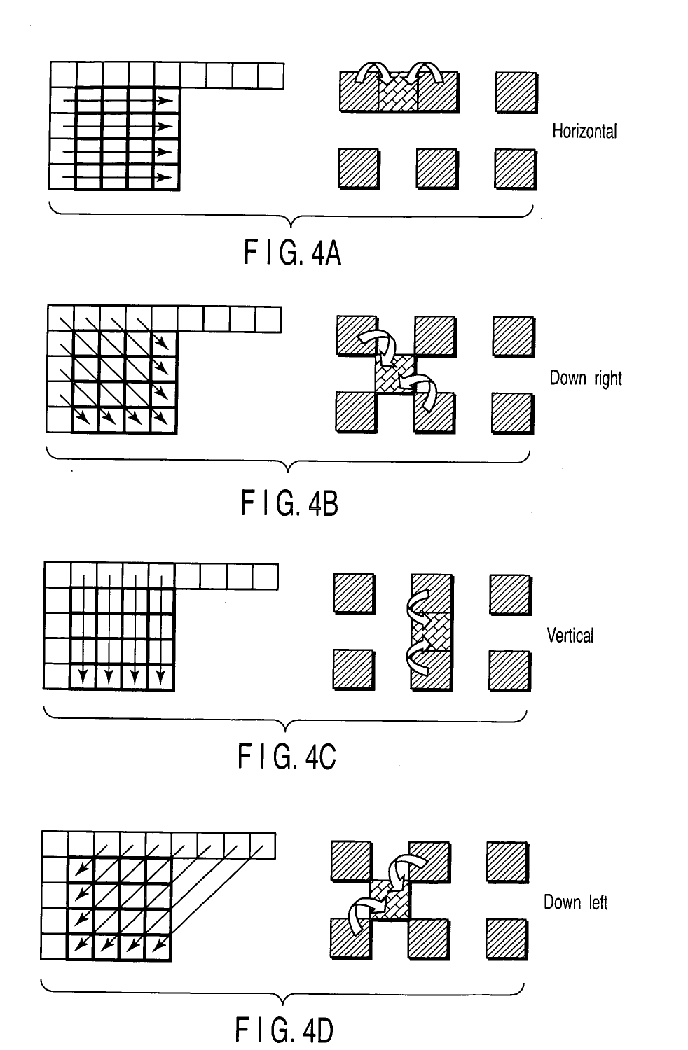

To the contrary, in the embodiment of the invention, as shown in FIGS. 4A to 4D, filter processing is performed in development directions according to the intra prediction modes when the interpolation pixels are obtained. In this manner, it is possible to calculate most suitable interpolation pixels according to image characteristics.

For example, the development direction of intra prediction is in the horizontal direction in FIG. 4A, and thus, interpolation is performed by use of only pixels in the horizontal direction among the pixels to be obtained. In the same manner, interpolation is performed by use of pixels in the diagonal directions in FIGS. 4B and 4D, and interpolation is performed by use of only pixels in the vertical direction in FIG. 4C. With regard to pixels used for interpolation, only pixels of the development direction may be employed. However, the contribution of pixels of development directions may be evaluated greatly by weighting, or pixels around pixels in one block as well as pixels in the block may be employed.

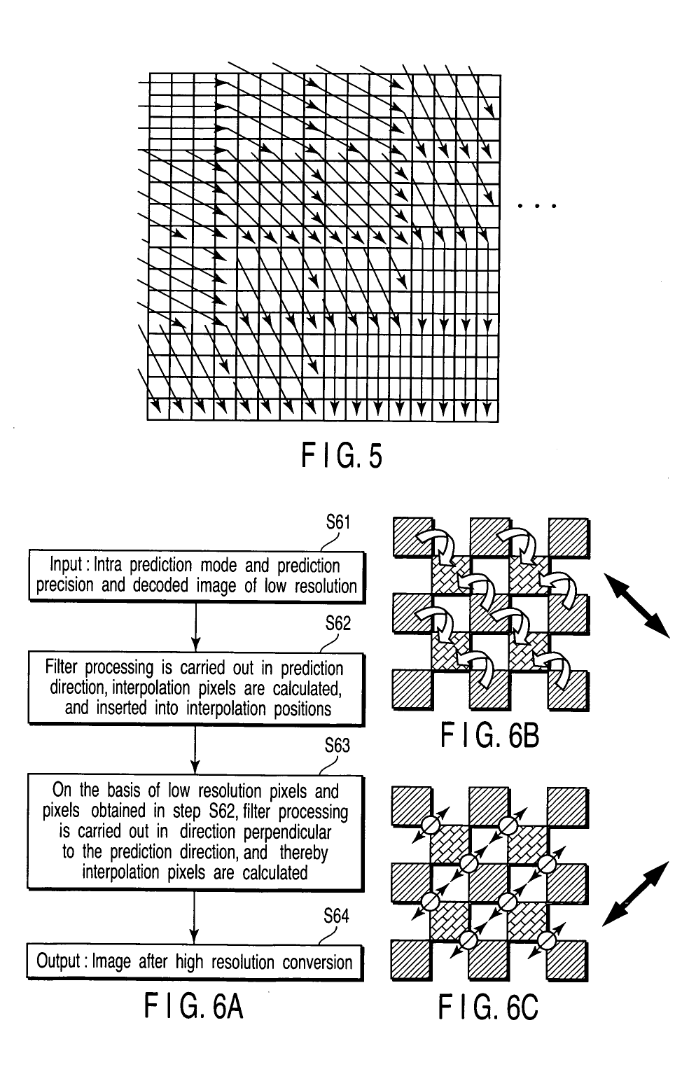

FIG. 5 is a view showing an example of intra prediction mode conditions in part of an image. As shown in FIG. 5, it is known that the intra prediction modes in adjacent blocks hardly change rapidly. Accordingly, interpolation may be made in consideration of not merely pixels neighboring both sides of a pixel to be interpolated, but also pixels that are apart.

FIGS. 6A to 6C are views for calculating interpolation pixel data according to one embodiment of the present invention. FIG. 6A is a flow chart showing calculation procedures, FIG. 6B is a view corresponding to step S62, and FIG. 6C is a view corresponding to step S63.

First, an intra prediction mode, prediction precision and a decoded image with low resolution are input (step S61). Along the prediction direction (direction) that the intra prediction mode shows, filter calculation is performed, and interpolation pixels are calculated (step S62). Next, on the basis of the original image and the interpolation pixel data obtained in step S62, other interpolation pixels are calculated by performing filter calculation in the direction perpendicular to the direction that the intra prediction mode shows (step S63). Then, the image after high resolution conversion is output (step S64).

In the above filter calculation (processing), an error may be made small by weighting with intra prediction precision. For example, when the prediction of intra prediction goes on well, the weight of the result of filter calculation using intra prediction is increased, and otherwise, the weight of the result of the ordinary filter calculation is increased, and interpolation pixels are calculated. In this manner, when an error of intra prediction is large, it can be prevented that interpolation pixels are calculate on the basis of data with large error.

The present invention is not limited to the above embodiments, but in steps of the embodiments thereof, the present invention may be embodied in several forms without departing from the sprit of essential characteristics thereof.

Intra prediction is performed on all the blocks in an I picture, and therefore, it contributes to high fineness of image data of the I picture. In addition, according to the present invention, high-definition images can be generated when intra prediction modes are selected in a P picture and a B picture as well. Further, if a high-definition reference frame is created even when an inter mode (movement prediction among frames) is selected, data is drawn out from the high-definition reference frame by use of motion vectors in the inter mode, whereby calculation of interpolation pixels can be compensated, so that improved performances of high resolution conversion processing may be expected. The above filter processing is just one example, and for example, a method of obtaining interpolation pixels by frequency component decomposition by DCT, and scaling DCT coefficient followed by performing IDCT may be considered.

Furthermore, it is unnecessary to use intra prediction for interpolation of all the pixels, but it is preferred to perform interpolation by the conventional method when there is no interrelation. Irrespective of presence or absence of interrelation, the conventional interpolation method may be employed in the place of intra prediction or changing weight according to the prediction precision of intra prediction, for example, by manual or according to error sizes. Note that, with regard to error size, a threshold value may be set externally (for example, by design, or by a user).

Further, the above respective embodiments include various steps of inventions, and by appropriate combination of plural constituent features disclosed herein, various inventions may be extracted.

According to the present invention, in the case where moving image data with low resolution is to be displayed on a display with high resolution, it is possible to obtain more high-definition images. Namely, high resolution conversion processing is performed by use of information of intra prediction, whereby it is possible to generate data that match the characteristics of original images as compared with the ordinary filter processing, and as a consequence, it becomes possible to obtain more high-definition converted images.

Especially, in the case of image data having redundancy in space, image data along the direction of intra prediction may be reproduced clearly without becoming blurred.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing device comprising:
means for extracting intra prediction information included in a bit stream of video codec; and
means for converting the resolution of image data into an image whose resolution is higher than that of an original image, wherein
the means for converting the resolution converts the pixels into high resolution images by performing interpolation processing for pixels of the image data on the basis of the intra prediction information.

2. An information processing device according to claim 1, wherein the means for converting the resolution includes means for performing interpolation processing by enlarging a weight of pixels in a development direction included in the intra prediction information, or by using only pixels in the development direction.

3. An information processing device according to claim 2, wherein, the weight of pixels is performed so that the closer to the original image the intra prediction information is, the greater the weight of interpolation processing on the basis of the intra prediction information is made.

4. An information processing device according to claim 1, wherein, in addition to pixels adjacent to pixels to be obtained by interpolation processing, pixels outside thereof are further used as pixels to be used for interpolation processing by the intra prediction information.

5. An information processing device according to claim 1, wherein the image to be interpolated by the intra prediction information is a P picture or a B picture.

6. An information processing method comprising:
a step of extracting intra prediction information included in a bit stream of video codec; and
a step of performing interpolation processing for pixels of the image data on the basis of the intra prediction information, and thereby converting the resolution of image data into an image whose resolution is higher than that of an original image.

7. An information processing device comprising:
a first unit configured to extract intra prediction information included in a bit stream of video codec; and
a second unit configured to convert the resolution of image data into an image whose resolution is higher than that of an original image, wherein
the second unit converts the pixels into high resolution images by performing interpolation processing for pixels of the image data on the basis of the intra prediction information.

8. An information processing device according to claim 7, wherein the second unit includes a unit configured to perform interpolation processing by enlarging a weight of pixels in a development direction included in the intra prediction information, or by using only pixels in the development direction.

9. An information processing device according to claim 8, wherein, the weight of pixels is performed so that the closer to the original image the intra prediction information is, the greater the weight of interpolation processing on the basis of the intra prediction information is made.

10. An information processing device according to claim 7, wherein, in addition to pixels adjacent to pixels to be obtained by interpolation processing, pixels outside thereof are further used as pixels to be used for interpolation processing by the intra prediction information.

11. An information processing device according to claim 7, wherein the image to be interpolated by the intra prediction information is a P picture or a B picture.
